(19) United States
(12) Patent Application Publication
(10) Pub. No.: US 2025/0111399 A1
(43) Pub. Date: Apr. 3, 2025

(54) INFORMATION PROCESSING APPARATUS AND INFORMATION PROCESSING METHOD

(71) Applicant: Hitachi, Ltd., Tokyo (JP)

(72) Inventors: Hidenori SAKANIWA, Tokyo (JP); Satoshi KATSUNUMA, Tokyo (JP); Hitoshi ISHIDA, Tokyo (JP); Toshihiko KASHIYAMA, Tokyo (JP)

(21) Appl. No.: 18/886,943

(22) Filed: Sep. 16, 2024

(30) Foreign Application Priority Data
Sep. 29, 2023 (JP) 2023-169932

(51) Int. Cl. G06Q 30/0201; G06Q 10/0639; G06Q 10/0875

(52) U.S. Cl. CPC G06Q 30/0206; G06Q 10/0639; G06Q 10/0875

(57) ABSTRACT

The present invention proposes an information processing apparatus and an information processing method which are capable of efficiently acquiring site data by selecting an optimum data model from a plurality of data models according to a factory site. A processor receives site identifying information for identifying a site from an input/output unit, calculates a first cost which is a cost of the site identified by the site identifying information based on site information of the site identified by the site identifying information, selects a specific data model corresponding to a site having a second cost similar to the first cost from among the plurality of data models based on the first cost and related information, and outputs the selected specific data model to the input/output unit.

### CROSS-REFERENCE TO RELATED APPLICATION

The present application claims priority from Japanese application JP2023-169932, filed on Sep. 29, 2023, the contents of which is hereby incorporated by reference into this application.

### TECHNICAL FIELD

The present invention relates to an information processing apparatus and an information processing method and is suited for application to, for example, an information processing apparatus for collecting data from a production facility of a factory using a plurality of pieces of data collection equipment arranged at the production facility of the factory.

### BACKGROUND ART

In recent years, many pieces of data collection equipment are arranged in a production line of a production facility of a factory, and site data are collected in real time using these many pieces of data collection equipment. The site data collected in this way are accumulated as a data lake in a platform. The platform includes not only such a data lake, but also data models and APIs.

When a user uses data collected at the production facility, an application operated by a user requests the site data from the platform. The platform is configured so that the API acquires data from the data lake using the data model(s) according to the request from the application.

As a known example of a method for collecting data at the production facility, there is PTL 1. With PTL 1, the influence of acquiring the site data on performance is comprehensively determined according to an access pattern from the application to determine whether or not to use the data model(s).

### CITATION LIST

### Patent Literature

PTL 1: Japanese Patent Application Laid-Open (Kokai) Publication No. 2011-154653

### SUMMARY OF THE INVENTION

### Problems to be Solved by the Invention

However, regarding the method disclosed in PTL 1, the influence on the performance of the production facility is comprehensively judged according to the access pattern from the application to judge whether or not to use the data model(s), but characteristics of the target site data to be acquired is not considered when making the above-described judgment and the data model to be used may not necessarily be an optimum data model.

The present invention was devised in consideration of the above-described circumstance and aims to propose an information processing apparatus and an information processing method which are capable of efficiently acquiring the site data selecting an optimum data model from a plurality of data models according to the factory site.

### Means to Solve the Problems

In order to solve such a problem, the present invention provides an information processing apparatus including: a memory having site data which is information regarding a site, a cost which is information indicating characteristics of the site, a plurality of data models which define connection relations between the site data, and related information by which the cost of each site is associated with the plurality of data models; a processor; and an input/output unit, wherein the processor includes: a cost calculation processing unit that receives site identifying information for identifying a site from the input/output unit and calculates a first cost which is a cost of the site identified by the site identifying information based on site information of the site identified by the site identifying information; and a data model selection unit that selects, based on the first cost and the related information, a specific data model corresponding to a site having a second cost similar to the first cost from among the plurality of data models and outputs the selected specific data model to the input/output unit.

Moreover, the present invention is an information processing method performed by an information processing apparatus including: a memory having site data which is information regarding a site, a cost which is information indicating characteristics of the site, a plurality of data models which define connection relations between the site data, and related information by which the cost for each site is associated with the plurality of data models; a processor; and an input/output unit, wherein the information processing method includes: a cost calculation processing step, which is executed by the processor, of receiving site identifying information for identifying a site from the input/output unit and calculating a first cost which is a cost of the site identified by the site identifying information based on site information of the site identified by the site identifying information; and a data model selection step, which is executed by the processor, of selecting, based on the first cost and the related information, a specific data model corresponding to a site having a second cost similar to the first cost from among the plurality of data models and outputting the selected specific data model to the input/output unit.

According to the information processing apparatus and method of the present invention, the site data can be acquired efficiently using an optimum specific data model because the optimum specific data model can be selected from among a plurality of data models according to the factory site so that the performance of the data collection equipment will be optimized according to the cost of the characteristic(s) of the site data.

### Advantageous Effects of the Invention

According to the present invention, it is possible to realize the information processing apparatus and the information processing method which are capable of efficiently acquiring the site data selecting the optimum data model from the plurality of data models according to the factory site.

### BRIEF DESCRIPTION OF DRAWINGS

FIG. 1 is a diagram illustrating a conceptual hardware configuration example of a data acquisition system according to the present embodiment.

FIG. 2 is a diagram illustrating an example of a software configuration of the data acquisition system according to the present embodiment.

FIG. 3 is a flowchart illustrating an example of cost calculation processing of a local site.

FIG. 4 is a flowchart illustrating an example of past performance results and cost information acquisition processing.

FIG. 5 is a diagram illustrating an example of past performance result information at each factory.

FIG. 6 is a diagram illustrating an example of site cost information at each factory.

FIG. 7 is a diagram illustrating an example of site cost aggregation information.

FIG. 8 is a diagram illustrating an example of data model performance information.

FIG. 9 is a diagram illustrating an example of an estimated data model table.

FIG. 10 is a flowchart illustrating an example of data model selection processing.

FIG. 11A is a diagram illustrating a data example for specifically explaining how a data model is selected in the data acquisition system according to the present embodiment.

FIG. 11B is a diagram illustrating a data example for specifically explaining how a data model is selected in the data acquisition system according to the present embodiment.

FIG. 11C is a diagram illustrating a data example for specifically explaining how a data model is selected in the data acquisition system according to the present embodiment.

### DESCRIPTION OF EMBODIMENTS

An embodiment of the present invention will be described below in detail with reference to the drawings.

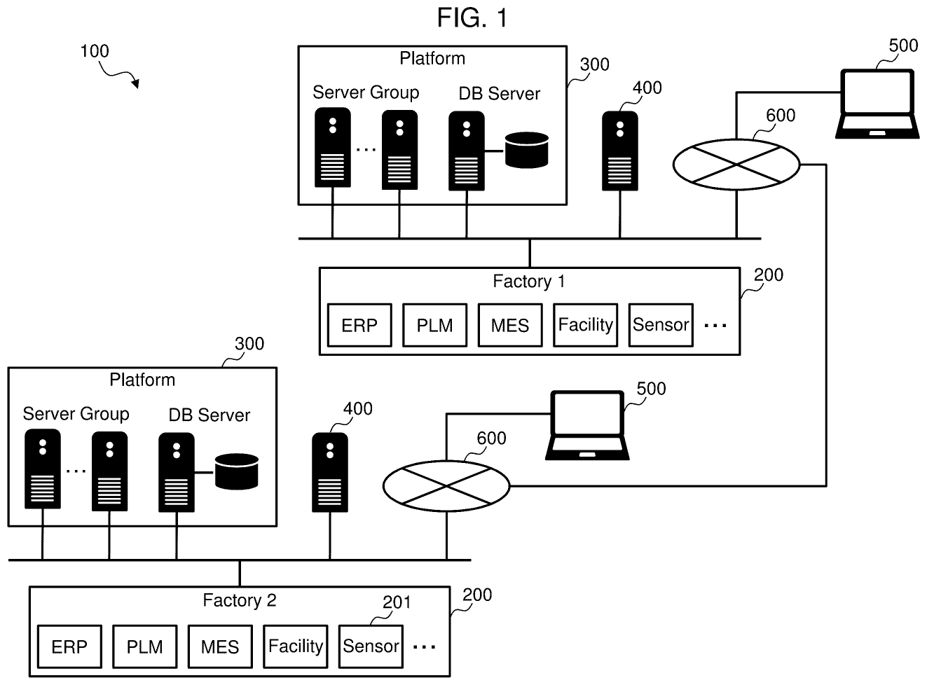

FIG. 1 illustrates a conceptual hardware configuration example of a data acquisition system 100 according to the present embodiment. The data acquisition system 100 includes a production line of a production facility of a factory 200, a platform 300, an application server 400, a terminal 500, and a network 600. This data acquisition system 100 is configured so that the factory 200, the platform 300, the application server 400, and the terminal 500 are connected to the network 600.

The factory 200 is provided with ERP (Enterprise Resource Planning), PLM (Product Lifecycle Management), an MES (Manufacturing Execution System), and a production facility, and at least one (in the present embodiment, a large number of) data collection apparatuses such as sensors are arranged in the production line of the production facility in a form so-called IoT (Internet of Things).

In the present embodiment, sensors 201 are mainly indicated as examples of the data collection apparatuses. A plurality of sensors 201 are provided in the production line of the production facility of the factory 200 and have a function that collects preset numerical values in the production line. The numerical values collected by the sensors 201 are output from the sensors 201 as site data.

The application server 400 has an application group operating to aggregate and analyze the site data from the sensors 201 arranged in the production line of the production facility of the factory 200 via the platform 300.

The terminal 500 is a terminal operated by a user and is a terminal apparatus which can manipulate the application group of the application server 400.

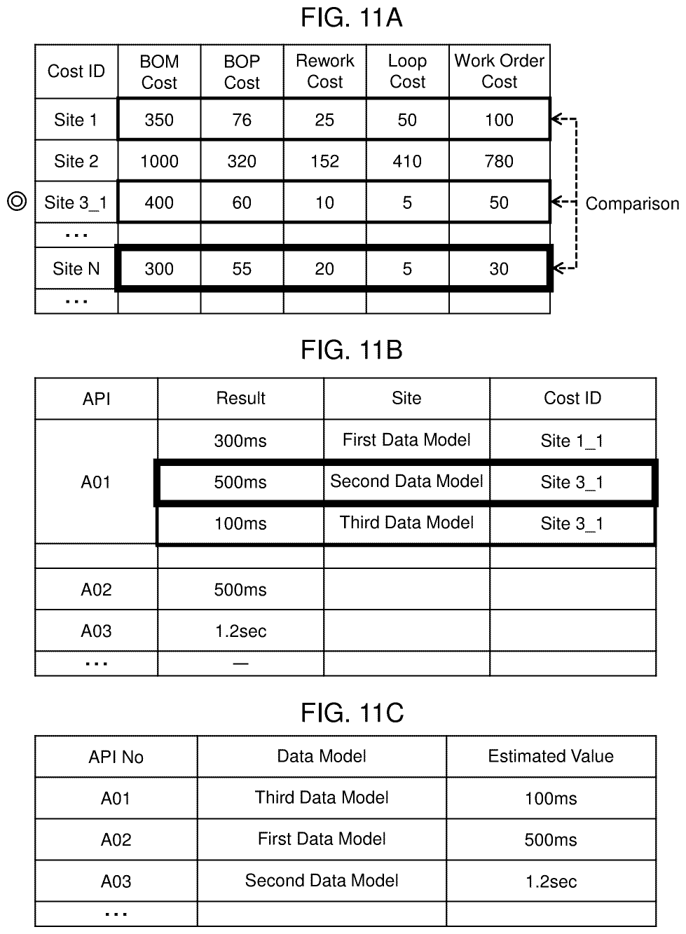

The platform 300 includes at least one server or database server. The platform 300 is configured by, for example, a computer and includes at least a memory, a processor, and an input/output unit (not illustrated in the drawing). The memory has site data which is information regarding a site(s), a cost(s) which is information indicating characteristics of the site(s), a plurality of data models which define connection relations between the site data, and related information by which the cost of each site is associated with the plurality of data models. The site data corresponds to, for example, a production plan and performance result data of the production facility. The related information corresponds to the sites, the costs, and the data models illustrated in FIG. 11A and FIG. 11B to be described later. The input/output unit receives site identifying information for identifying the relevant site and outputs a specific data model selected as described later. The server group accumulates the site data from the sensors 201 provided in the production line of the production facility of the factory 200 in a format using the data model(s). The server group is provided with a plurality of types of data models. Incidentally, the relevant site data may be accumulated in the database server. The details of the platform 300 will be described later.

Incidentally, the platform 300 and the application server 400 may adopt a so-called on-premise type managed in an in-house environment or may adopt a so-called cloud type using a system in resources provided by a vendor.

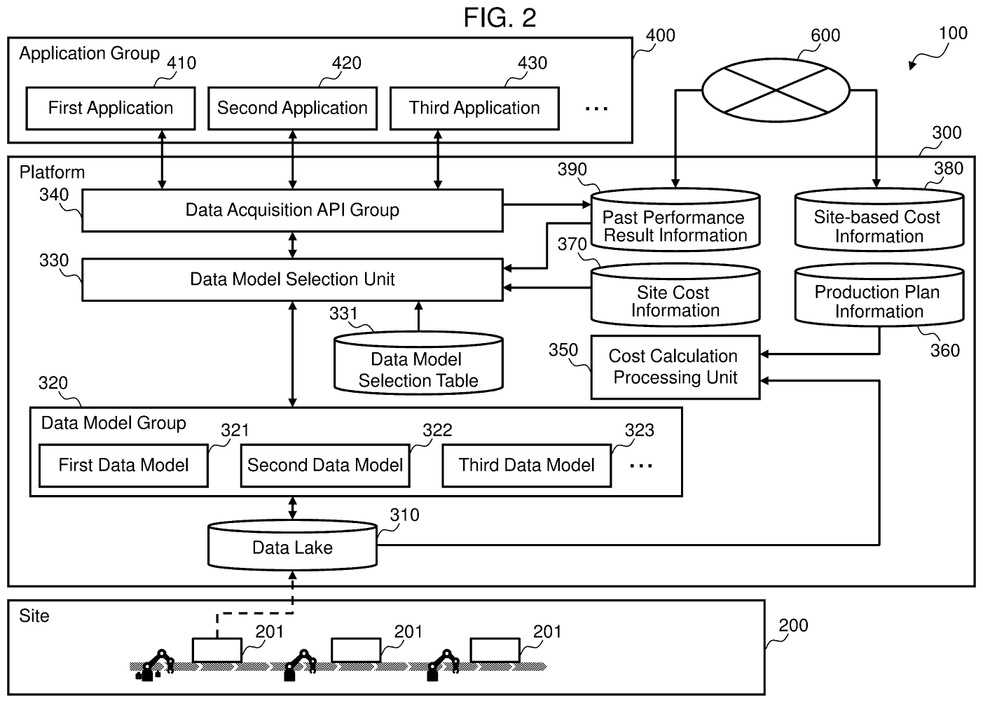

FIG. 2 illustrates an example of a software configuration of the data acquisition system 100 according to the present embodiment. Incidentally, regarding FIG. 1 described above, it is explained by assuming that there are a plurality of factories; however, regarding FIG. 2 and subsequent drawings, unless it is necessary to refer to a plurality of factories, the factory 2 is mainly illustrated as an example.

The data acquisition system 100 is configured so that a plurality of sensors 201 which are provided in the production line of the production facility of the factory 200, the platform 300, and the application server 400 are connected to the network 600.

As described above, the production line of the production facility of the factory 200 is provided with the plurality of sensors 201 as a plurality of pieces of data collection equipment for collecting site data of each production facility. The sensors 201 collect values regarding preset measurement content regarding the production line of the production facility in operation and output the site data.

The platform 300 is an example of an information processing apparatus and includes at least a plurality of data model groups 320, a cost calculation processing unit 350, site-based cost information 380, and a data model selection unit 330 and may preferably further include a data lake 310, a data acquisition API group 340, production plan information 360, and past performance result information 390.

The data lake 310 accumulates the site data collected by each sensor 201 provided in the production line of the production facility of the factory 200. Incidentally, the site data may be accumulated in a database (not illustrated in the drawing) instead of the data lake 310.

The data model group 320 includes a first data model 321, a second data model 322, a third data model 323, and so on. The first data model 321, the second data model 322, the third data model 323, and so on are data models regarding performance results of the plurality of sensors 201 provided in the production line of the production facility of the factory 200. In the embodiment described below, it is assumed that the platform 300 has mainly three data models such as the first data model 321, the second data model 322, and the third data model 323.

Incidentally, each data model of the data model group 320 can adopt, for example, a structure such as a so-called ER (Entity Relationship) diagram connected by a Key, a graph structure, a tree structure, or a network structure. The platform 300 has a plurality of data models of various structures and may be in a form to allow a specific data model to be selected from the plurality of data models so that data can be efficiently provided to a request from the application server 400 using various kinds of costs.

The term “cost(s)” used in the present embodiment means, for example, an index for determining which data model should be used for analysis according to the scale (amount) and complexity of data which can be acquired from the site, that is, an index quantifying data characteristics which are determined according to the scale (amount) and complexity of the data. In the present embodiment, such cost(s) includes, for example, an actual cost(s), a planned cost(s), and a site cost(s). This actual cost includes a rework cost, a loop cost, and a work order cost, and this planned cost includes a bill of materials (BOM) cost and a bill of process (BOP) cost.

The site-based cost information 380 is information regarding the site cost indicating the scale of the production facility and the degree of difficulty in producing finished products in the production line of the production facility of the factory 200.

The past performance result information 390 is information regarding past performance results indicating performance results when the site data was acquired in the past by each sensor 201 provided in the production line of the production facility of the factory 200.

The production plan information 360 is information regarding a production plan of finished products and their components to be produced in the production line of the production facility of the factory 200.

The cost calculation processing unit 350 calculates a first cost (hereinafter also abbreviated as the “cost”) that is a cost of the site identified by the site identifying information based on the site information of the site identified by the site identifying information received from the aforementioned input/output unit. The cost calculation processing unit 350 calculates the actual cost based on the performance result data of the production facility as characteristics of the site data. Specifically, the cost calculation processing unit 350 calculates the cost based on the information regarding the production plan based on the production plan information 360 and the data of each sensor 201 accumulated in the data lake 310 and generates the site cost information 370 as the cost indicating the scale of the production facility and the difficulty of production for each production line of the production facility of the factory 200. Incidentally, the above-described processing by the cost calculation processing unit 350 may be executed by the data model selection unit 330 or the data model selection unit 330 may cause the cost calculation processing unit 350 to execute the processing.

Under this circumstance, in the present embodiment, the “cost” has influence on the performance because the site data in the production facility vary according to the difference in processes of the production facility and an amount of work, an amount of products to be handled, and the complexity of the work. For example, work results, etc. at a factory vary significantly between a case where one type of products are manufactured in a large quantity and a case where a variety of products are manufactured respectively in a small quantity, even if the same data model is adopted.

In the present embodiment, the production facility which is more complicated has greater influence on the performance, so the cost which can affect the performance is calculated regarding each production facility. Specifically speaking, the present embodiment is characterized in that the data model to be selected is flexibly changed according to the cost (of the characteristics of the site data) due to the difference specific to the production facility.

Based on the cost (the first cost) calculated by the cost calculation processing unit 350 and the related information, the data model selection unit 330 selects a specific data model corresponding to a site having another cost (a second cost) similar to the above-mentioned cost (the first cost) from among a plurality of data models and outputs the selected specific data model to the input/output unit. This data model selection unit 330 refers to a data model selection table 331 according to the past performance results regarding the plurality of sensors 201 and the cost of the characteristics of the site data of the production facility and selects an optimum specific data model from among a plurality of data models so that the performance of the plurality of sensors 201 will be optimized. When the specific data model selected in this way becomes optimum, the performance results of the site data from a sensor 201a arranged in the production line of the production facility can be favorable.

The data model selection unit 330 calculates a planned cost based on the production plan of the production facility as characteristics of the site data. The data model selection unit 330 checks whether or not a planned cost and an actual cost of a new site matches a combination of the planned cost and the actual cost of the production facility, refers to the performance result data of the site which has the closest combination, and determines a data model to be selected for the new production facility.

The data model selection unit 330 calculates the bill of materials (BOM) cost and the bill of process (BOP) cost as the planned cost from the bill of materials (BOM) and the bill of process (BOP) of the production facility. It is assumed that the BOM is more complicated when there are a larger number of intermediate products and materials for a product. It is assumed that the BOM cost is equal to Σ the number of end leaves. Incidentally, the number of end leaves indicates the number of material items of intermediate products constituting the finished products.

It is assumed that the BOP is more complicated when there are many processes in the production line of the production facility and the process hierarchy is deeper. It is assumed that the BOP cost is equal to Σ hierarchy multiplied by the number of processes. Incidentally, the number of processes indicates the number of downstream and subordinate processes constituting upstream processes.

Incidentally, in the present embodiment, not only the production plan, but also resource information of the site (for example, platform-based CPU performance) may be acquired. This is because the performance regarding the acquisition of the site data differs between a site using a high-performance computer(s) and a site using a low-performance computer(s).

The data acquisition API group 340 includes a large number of APIs (Application Programming Interfaces) for collecting the site data from the sensors 201 using the data model selected by the data model selection unit 330. The data acquisition API group 340 is an example of an API providing unit and provides a plurality of applications with the APIs (Application Programming Interface) for using the site data collected by the sensors 201 using the specific data model selected by the data model selection unit 330. The data acquisition API group 340 measures, for example, an execution starting time to a completion time using the APIs included in the data acquisition API group 340 regarding the performance of each sensor 201 and collects the performance results of each sensor 201. With this arrangement, it is possible to detect that the accumulated data at the factory 200 has increased, so a conventional data model can no longer work with sufficient performance.

Further, when it becomes impossible to ensure sufficient performance, the data acquisition API group 340 performs processing for selecting a data model capable of ensuring better performance from performance information of other factories.

The data model selection unit 330 calculates a bill of materials (BOM) cost and a bill of process (BOP) cost as the planned cost from the bill of materials (BOM) and the bill of process (BOP) of the production facility.

The data model selection unit 330 extracts reworks, loops, and work order changes performed in the production facility from the past performance results of the data collection equipment and respectively calculates a rework cost, a loop cost, and a work order cost, respectively, as the actual cost.

The application server 400 includes, for example, a first application 410, a second application 420, and a third application 430 as a plurality of applications which use the site data acquired by the plurality of sensors 201 using a data model via the data acquisition API group 340. In the present embodiment below, an explanation will be provided by assuming that the application server 400 includes the first application 410, the second application 420, and the third application 430.

The data acquisition system 100 according to the present embodiment has the above-described configuration and an operation example of the data acquisition system 100 will be described next. Firstly, regarding its outline, the present embodiment is a data collection method for collecting the site data by the sensors 201 using a data model regarding the performance results of sensors 201 for collecting the site data of the production facility of the factory and relates to a data acquisition method including: a data model selection step in which a data model selection unit 330 selects a specific data model from among the plurality of data models so that the performance of the sensors 201 will be optimized according to the past performance results of the sensors 201 and the cost of the characteristics of the site data; and an API providing step of providing a plurality of applications 410 with an API(s) (Application Programming Interface(s)) for using the site data collected by the sensors 201 using the specific data model selected by the data model selection unit 330, via a data acquisition API group 340. Next, the cost calculation will be described.

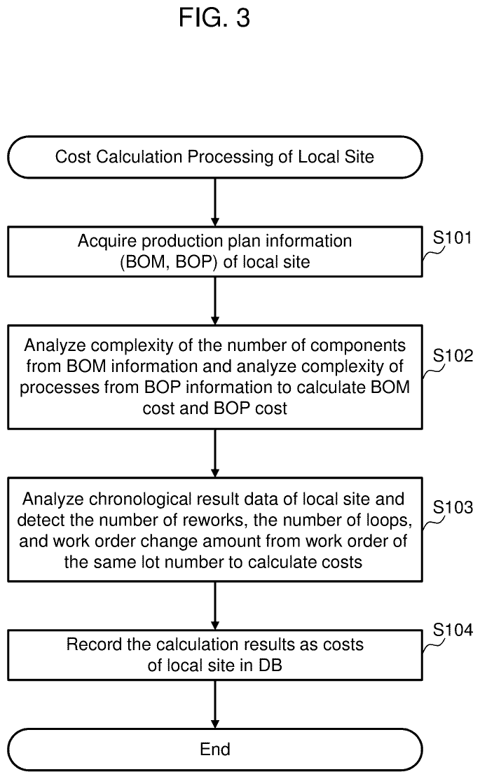

FIG. 3 is a flowchart illustrating an example of cost calculation processing of a local site. A local production facility herein used indicates, for example, a production facility of the factory 200 described above.

In step S101, the cost calculation processing unit 350 in the platform 300 acquires the production plan information 360 of the local site. This production plan information 360 includes BOM information and BOP information. Next, in step S102, the cost calculation processing unit 350 calculates the BOM cost by analyzing the complexity of the number of components from the BOM information and calculates the BOP cost by analyzing the complexity of the processes from the BOP information.

Then, in step S103, the cost calculation processing unit 350 analyzes chronological performance result data of the local site, detects the number of reworks, the number of loops, and the amount of work order changes from the work order of the same lot number, and calculates the rework cost, the loop cost, and the work order change amount cost. Subsequently, in step S104, the cost calculation processing unit 350 records the calculation results as site cost information 370 corresponding to the local site.

The term “rework” means that when a product produced as a result of a certain work is rejected, the work is performed again on the rejected product. It is assumed that the rework cost is equal to Σ the number of works multiplied by the number of times. The number of analysis lines increases as many as the number of reworks. The term “loop” means that the same work is repeated regarding a certain work. It is assumed that the loop cost is equal to Σ the number of works multiplied by the number of times. The number of analysis lines increases as many as the number of loops. The term “work order change” means that the work order of multiple consecutive works is changed. It is assumed that the work order cost is equal to Σ master difference multiplied by the number of times. Incidentally, the master difference is the difference from a standard work order. It is assumed that performance (result) analysis such as a job shop type is cost-consuming.

Under this circumstance, the timing to execute the cost calculation processing of the local site as the user's own local site where the user intends to execute an API selecting a certain data model may be periodic such as once every several months. Also, the timing may be a timing when a change occurs in the work at the site because it may be better to change the data model when the data increases over time. This is because the cost may possibly change significantly when the work changes.

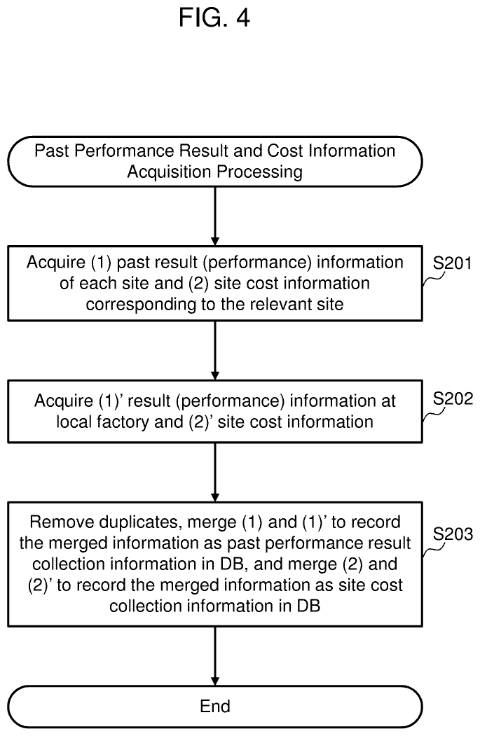

FIG. 4 is a flowchart illustrating an example of past performance results and cost information acquisition processing. Firstly, in step S201, the data model selection unit 330 acquires (1) past performance result information (past performance result information 390) at each site and (2) site cost information 370 corresponding to the relevant site. Next, in step S202, the data model selection unit 330 acquires (1)′ performance result information (result (performance) information) at a local site of the local factory 200 and (2)′ site cost information 370 corresponding to that site.

In step S203, the data model selection unit 330 removes duplications, merges (1) the past performance result information (the past performance result information 390) and (1)′ the performance result information to record the merged information in a database as past performance result collection information and merges (2) the site cost information 370 and (2)′ the site cost information 370 to record the merged information in the database as site cost collection information.

Under this circumstance, in the present embodiment, the past result information and the cost information may be acquired from some designated factories or from all factories. Moreover, the past result information and the cost information of the respective sites may be aggregated in one of the servers and some data (data of a factory with a similar cost) may be acquired therefrom. Furthermore, the past result information and the cost information of each site may be acquired periodically, or the information of a site with any update may be acquired checking whether there is any update or not, or the information may be acquired at a necessary timing.

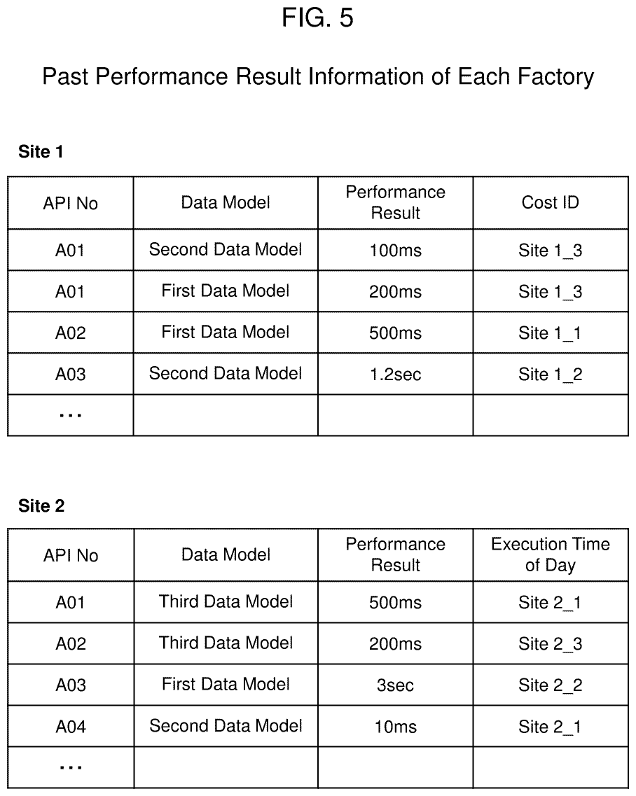

FIG. 5 illustrates an example of the past performance result information at each factory. Under this circumstance, Site 1 and Site 2 are illustrated as examples. Regarding the past performance result information of Site 1, a data model, a performance result, and a cost ID are managed for each API number. For example, when the API number is “A01,” the data model is a “second data model,” the performance result is “100 ms,” and the cost ID is “Site 1_3.”

Meanwhile, regarding the past performance result information of Site 2, the data model, the performance result, and the cost ID are managed for each API number. For example, when the API number is “A01,” the data model is a “third data model,” the performance result is “500 ms,” and the cost ID is “Site 2_1.”

Under this circumstance, the API number may be the API name such as “A01” or may be, for example, “A01_0001” to show which version of the relevant API it is. Incidentally, the performance of the API for the same processing may differ depending on its version. Moreover, the past result information and the site cost information are used as a set for each factory.

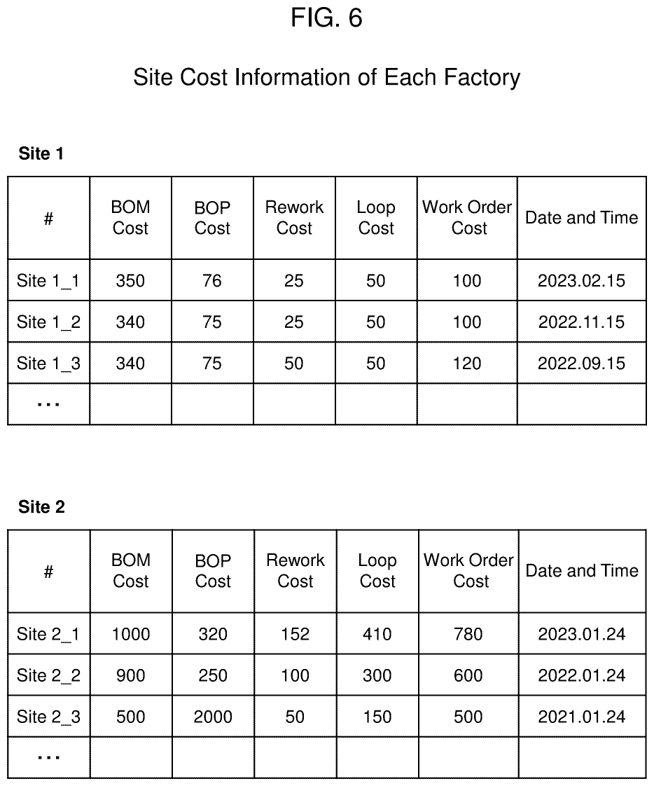

FIG. 6 illustrates an example of the site cost information at each factory. Under this circumstance, Site 1 and Site 2 are illustrated as examples. Regarding the site cost information of Site 1, a BOM cost, a BOP cost, a rework cost, a loop cost, a work order cost, and a date and time are managed for each number (corresponding to “#” in the drawing). For example, when the number is “Site 1_1,” the BOM cost is “350,” the BOP cost is “76,” the rework cost is “25,” the loop cost is “50,” the work order cost is “100,” and the date and time is “February 15, 2023.”

Under this circumstance, an ID capable of identifying each factory is assigned as a cost ID. This may be recalculated every several months or may be recalculated and changed based on these processes and works at the timing when the process(es) and work(s) change.

Meanwhile, regarding the site cost information of Site 2, the BOM cost, the BOP cost, the rework cost, the loop cost, the work order cost, and the date and time are managed for each number (corresponding to “#” in the drawing). For example, when the number is “Site 2_1,” the BOM cost is “1000,” the BOP cost is “320,” the rework cost is “152,” the loop cost is “410,” the work order cost is “780,” and the date and time is “January 24, 2023.” Under this circumstance, at and after the number “Site 2_2,” a product(s) to be manufactured is changed and the respective costs thereby change significantly.

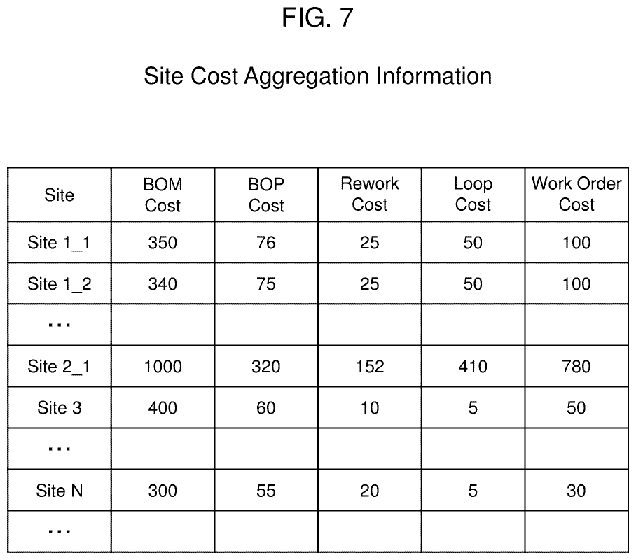

FIG. 7 illustrates an example of site cost aggregation information. Regarding the site cost aggregation information, the BOM cost, the BOP cost, the rework cost, the loop cost, and the work order cost are managed for each site. For example, when the site is “Site 1_1,” the BOM cost is “350,” the BOP cost is “76,” the rework cost is “25,” the loop cost is “50,” and the work order cost is “100.”

Under this circumstance, a table in which the costs of the respective sites are collected may be used as follows. For example, the cost may be aggregated at each site or any one of the servers may aggregate the costs and the aggregated table may be downloaded at each site. Moreover, combinations of similar costs may be clustered to aggregate the performance by an average value(s) and a contrivance may be made to reduce a search load reducing a total number of aggregated tables.

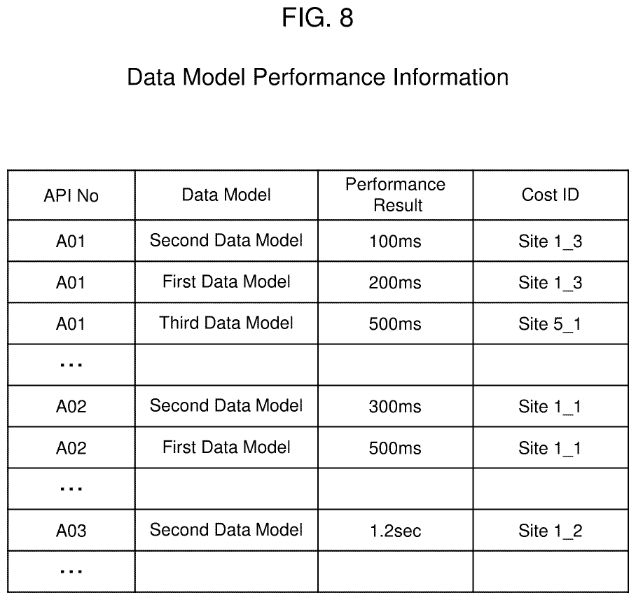

FIG. 8 illustrates an example of data model performance information. Regarding the data model performance information, a data model, a performance result, and a cost ID are managed for each API number. For example, when the API number is “A01,” the data model is a “second data model,” the performance result is “100 ms,” and the cost ID is “Site 1_3.”

Under this circumstance, the data may be aggregated at each site or any one of the servers may aggregate the data and the aggregated table may be downloaded at each site. Moreover, regarding the performance measured at the same site and with the same data model, all data may be kept, or the data with the best performance may be recorded as the performance result, or an average value may be recorded.

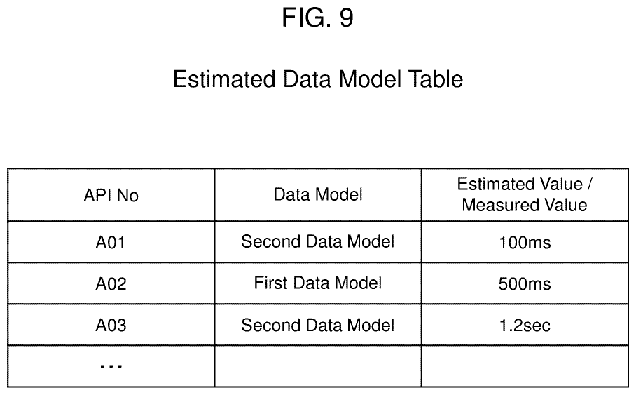

FIG. 9 illustrates an example of an estimated data model table. The estimated data model table manages a data model and an estimated/measured value for each API number. For example, when the API number is “A01,” the data model is the “second data model” and the estimated value/measured value is “100 ms.”

Under this circumstance, the estimated result according to the cost at each site may be retained, so that the estimation processing will not have to be performed every time. Moreover, when an actual measured value is worse than this estimated value by a predetermined percentage, the search is conducted to check whether or not there is any data model that would further improve the performance.

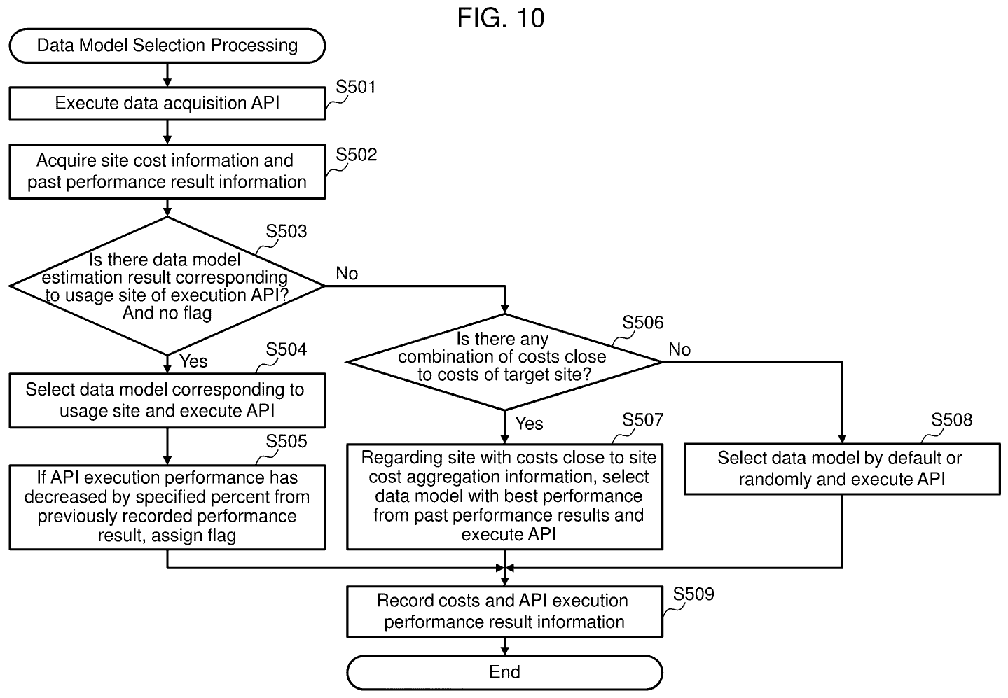

FIG. 10 is a flowchart illustrating an example of data model selection processing. The data model selection processing is executed by the aforementioned data model selection unit 330. In step S501, the data model selection unit 330 executes the data acquisition API group 340. Next, in step S502, the data model selection unit 330 acquires the site cost information 370 and the past performance result information 390.

Then, in step S503, the data model selection unit 330 checks whether or not there is any estimation result in a data model estimation table (not illustrated in the drawing). That is, the data model selection unit 330 determines whether or not there is any data model estimation result corresponding to a usage site of the executed API in the data model estimation table and with “no flag.” Under this circumstance, “no flag” means that the processing does not proceed to processing for selecting a data model with a similar cost.

If an affirmative result is obtained in step S502, in step S504, the data model selection unit 330 selects a data model corresponding to the usage site and executes the API. Next, in step S505, if the API execution performance has degraded by a predetermined percentage from the previously recorded performance result, the data model selection unit 330 assigns a flag. Under this circumstance, assigning the flag means that sufficient performance is not obtained although a data model corresponding to the usage site has been selected, the processing proceeds to work of selecting the data model with a similar cost.

Subsequently, in step S509, the data model selection unit 330 records the costs and the API execution performance result information.

Meanwhile, if a negative result is obtained in step S503, in step S506, the data model selection unit 330 determines whether or not there is any combination of costs close to that of the target site. If there is any combination of costs which is close to that of the target site, in step S507, the data model selection unit 330 selects a specific data model with the best performance from the past performance results for the site with the closest costs from the site cost aggregation information and executes the API. Then, the data model selection unit 330 executes step S509 described above.

Meanwhile, if there is no combination of costs close to that of the target site, in step S508, the data model selection unit 330 selects a data model by default or at random and executes the API. Next, the data model selection unit 330 executes step S509 described above.

FIGS. 11A to 11C illustrate data examples for specifically explaining how the data model is selected in the data acquisition system 100 according to the present embodiment (corresponding to the “sites, costs, and data models” as an example of the aforementioned related information). Under this circumstance, it is assumed that the first data model 321 and the second data model 322 are mounted in the platform 300, and a case of applying the data model to Site N is assumed.

### Procedure A

In the platform 300, the data model selection unit 330 searches for a site cost close to that of Site N. For example, as illustrated in FIG. 11A, regarding the site cost aggregation information for Site N, the BOM cost is “300,” the BOP cost is “55,” the rework cost is “20,” the loop cost is “5,” and the work order cost is “30.” Contrarily, regarding the site cost aggregation information for Site 1, the BOM cost is “350,” the BOP cost is “76,” the rework cost is “25,” the loop cost is “50,” and the work order cost is “100.” Regarding the site cost aggregation information for Site 3_1, the BOM cost is “400,” the BOP cost is “60,” the rework cost is “10,” the loop cost is “5,” and the work order cost is “50.”

The data model selection unit 330 compares the site cost aggregation information for Site N with the site cost aggregation information for Site 1 and also compares the site cost aggregation information for Site N with the site cost aggregation information for Site 3_1. Based on these comparison results, the data model selection unit 330 selects a specific data model from a plurality of data model groups 320 so that the combination of the BOM cost, the BOP cost, the rework cost, the loop cost, and the work order cost will become close to the site cost aggregation information for Site N. Specifically saying, the data model selection unit 330 selects, for example, a data model having a graph shape close to that of these costs when they are graphed. Incidentally, the data model selection unit 330 may evaluate whether there is any data model with similar data concerning the production plan and the actual results

### Procedure B

Next, the data model selection unit 330 acquires the site data for Site 3 close to Site N using the past performance data. For example, as illustrated in FIG. 11B, when the API number is “A01,” the data model selection unit 330 compares the past performance result information in which the result is “500 ms,” the site is the “second data model,” and the cost ID is “Site 3_1,” with the past performance result information in which the result is “1000 ms,” the site is the “third data model,” and the cost ID is “Site 3_1,” and adopts the third data model 323 when executing the API whose API number is “A01” at Site N because the “third data model” has better performance.

### Procedure C

Then, the data model selection unit 330 creates a data model and an estimated value to be selected by each API. For example, as illustrated in FIG. 11C, the data model selection unit 330 creates an estimated data model in which the API number is “A01,” the data model is the “third data model,” and the estimated value is “100 ms,” an estimated data model in which the API number is “A02,” the data model is the “first data model,” and the estimated value is “500 ms,” and an estimated data model in which the API number is “A03,” the data model is the “second data model,” and the estimated value is “1.2 sec.”

Based on the estimated data models created as described above, the data model selection unit 330 can estimate which data model works with high performance when using the API at Site N, and select a specific data model from among a plurality of data model groups 320.

In the present embodiment as described above, the platform 300 includes: a memory having site data that is information regarding a site, a cost that is information indicating characteristics of the site, a plurality of data models that define connection relations between the site data, and related information by which the cost for each site is associated with the plurality of data models; a processor; and an input/output unit, wherein the processor includes: a function (the cost calculation processing unit 350) that receives site identifying information for identifying the site from the input/output unit and calculates a first cost which is the cost of the site identified by the site identifying information based on the site information of the site identified by the site identifying information; and a function (the data model selection unit 330) that selects a specific data model corresponding to a site having another cost (a second cost) similar to the first cost from among the plurality of data models based on the first cost and the related information and outputs the selected specific data model to the input/output unit.

The information processing method according to the present embodiment is an information processing method of the platform 300 including: a memory having site data that is information regarding a site, a cost that is information indicating characteristics of the site, a plurality of data models that define connection relations between the site data, and related information by which the cost for each site is associated with the plurality of data models; a processor; and an input/output unit, wherein the information processing method includes: a cost calculation processing step in which the processor of the platform 300 (that is, the cost calculation processing unit 350) receives site identifying information for identifying the site from the input/output unit and calculates a first cost which is the cost of the site identified by the site identifying information based on the site information of the site identified by the site identifying information; and a data model selection step in which the processor of the platform 300 (that is, the data model selection unit 330) selects a specific data model corresponding to a site having a second cost similar to the first cost from among the plurality of data models based on the first cost and the related information and outputs the selected specific data model to the input/output unit.

With this arrangement, an optimum specific data model can be selected from among the plurality of data models 321, 322, and 323 according to the cost of the characteristics of the site data at the factory site and the site data can be acquired efficiently from the sensor 201a provided in the production line of the production facility of the factory 2 using the optimum specific data model.

In the present embodiment, the platform 300 including a plurality of data model groups 320, the data model selection unit 330, and the data acquisition API group 340 is provided.

With this configuration, it is possible to provide the platform 300 which can be used in various sites by efficiently acquiring the site data selecting the optimum specific data model from among the plurality of data models 321, 322, and 323 according to the scale of each site and the characteristic specific to the production site.

In the present embodiment, the data model selection unit 330 calculates the planned cost based on the production plan of the production facility as a characteristic of the site data. With this arrangement, by using the calculated planned cost, the site data can be acquired efficiently from the sensor 201a provided in the production line of the production facility of the factory 2 using the optimum specific data model from among the plurality of data models 321, 322, and 323 according to the site of the factory 2.

In the present embodiment, the cost calculation processing unit 350 of the platform 300 calculates the actual cost based on the performance result data of the production facility as a characteristic of the site data. With this arrangement, the processing load of the data model selection unit 330 can be reduced.

With this arrangement, by using the calculated actual cost, the site data can be acquired efficiently from the sensor 201a provided in the production line of the production facility of the factory 2 using the optimum specific data model from among the plurality of data models 321, 322, and 323 according to the site of the factory 2.

In the present embodiment, the data model selection unit 330 checks whether or not a planned cost and an actual cost of a new site matches a combination of the planned cost and the actual cost of the production facility, refers to the performance result data of a site which has the closest combination, and decides a data model to be selected for the new production facility.

With this arrangement, by using the performance result data of the site which has the closest combination, the site data can be acquired efficiently from the sensor 201a provided in the production line of the production facility of the factory 2 using the optimum specific data model from among the plurality of data models 321, 322, and 323 according to the site of the factory 2.

In the present embodiment, the data model selection unit 330 calculates the bill of materials (BOM) cost and the bill of process (BOP) cost as the planned cost from the bill of materials (BOM) and the bill of process (BOP) of the production facility.

With this arrangement, by using the BOM cost and the BOP cost, the site data can be acquired efficiently from the sensor 201a provided in the production line of the production facility of the factory 2 using the optimum specific data model from among the plurality of data models 321, 322, and 323 according to the site of the factory 2.

In the present embodiment, the data model selection unit 330 extracts the rework(s), the loop(s), and the work order change(s) performed in the production facility from the past performance result information 390 regarding the past performance result of the sensors 201 and calculates the rework cost, the loop cost, and the work order cost, respectively, as the actual cost.

With this arrangement, by using the actual cost including the rework cost, the loop cost, and the work order cost, the site data can be acquired efficiently from the sensor 201a provided in the production line of the production facility of the factory 2 using the optimum specific data model from among the plurality of data models 321, 322, and 323 according to the site of the factory 2.

In the present embodiment, the data model selection unit 330 selects a specific data model from among the plurality of data models 321, 322, and 323 so that a combination of the bill of materials (BOM) cost, the bill of process (BOP) cost, the rework cost, the loop cost, and the work order cost becomes close to that of a target.

With this arrangement, by using the specific data model having the close combination of the bill of materials (BOM) cost, the bill of process (BOP) cost, the rework cost, the loop cost, and the work order cost from among the plurality of data model groups 320, the site data can be acquired efficiently from the sensor 201a provided in the production line of the production facility of the factory 2.

Incidentally, the present embodiment has described that one data model is selected from among a plurality of data models; however, the present invention is not limited to this example and a plurality of data models may be selected from among many data models.

With the data acquisition system 100 according to the present embodiment, the sensors 201 are illustrated as an example of the data collection equipment provided in the production line of the production facility at a factory site; however, the present invention is not limited to this example and any one of other data collection equipment, an ERP, a PLM, an MES, and other production facilities, or any combination thereof may be exemplified.

### INDUSTRIAL AVAILABILITY

The present invention can be applied to the information processing apparatus for acquiring the site data from the data collection apparatus provided in the production line of the production facility of a factory using a data model(s).

### REFERENCE SIGNS LIST

100: data acquisition system
200: factory
201: sensor
300: platform
310: data lake
320: data model group
330: data model selection unit
340: data acquisition API group
350: cost calculation processing unit
360: production plan information
370: site cost information
380: site-based cost information
390: past performance result information
400: application server
410: application

1. An information processing apparatus comprising:
a memory having site data which is information regarding a site, a cost which is information indicating characteristics of the site, a plurality of data models which define connection relations between the site data, and related information by which the cost for each site is associated with the plurality of data models;
a processor; and
an input/output unit,
wherein the processor includes:
a cost calculation processing unit that receives site identifying information for identifying a site from the input/output unit and calculates a first cost which is a cost of the site identified by the site identifying information based on site information of the site identified by the site identifying information; and
a data model selection unit that selects, based on the first cost and the related information, a specific data model corresponding to a site having a second cost similar to the first cost from among the plurality of data models and outputs the selected specific data model to the input/output unit.

2. The information processing apparatus according to claim 1,
wherein the data model selection unit selects the specific data model from among the plurality of data models so that performance of a data collection apparatus for collecting the site data will be optimized according to past performance results of the data collection apparatus and a cost of characteristics of the site data.

3. The information processing apparatus according to claim 2,
wherein the data model selection unit calculates a planned cost based on a production plan of a production facility as a characteristic of the site data.

4. The information processing apparatus according to claim 3,
wherein the cost calculation processing unit calculates an actual cost based on performance result data of the production facility.

5. The information processing apparatus according to claim 4,
wherein the data model selection unit checks whether or not a planned cost and an actual cost of a new site matches a combination of the planned cost and the actual cost of the production facility, refers to performance result data of a site whose combination is the closest, and determines the specific data model to be selected at a new production facility.

6. The information processing apparatus according to claim 3,
wherein the data model selection unit calculates a bill of materials (BOM) cost and a bill of process (BOP) cost as the planned cost from a bill of materials (BOM) and a bill of process (BOP) of the production facility.

7. The information processing apparatus according to claim 4,
wherein the data model selection unit extracts a rework, a loop, and a work order change performed in the production facility from past performance result information regarding past performance results of the data collection apparatus and respectively calculates a rework cost, a loop cost, and a work order cost as the actual cost.

8. The information processing apparatus according to claim 6,
wherein the data model selection unit selects the specific data model from among the plurality of data models so that a combination of the bill of materials (BOM) cost, the bill of process (BOP) cost, the rework cost, the loop cost, and the work order cost becomes close to that of a target.

9. An information processing method performed by an information processing apparatus including: a memory having site data which is information regarding a site, a cost which is information indicating characteristics of the site, a plurality of data models which define connection relations between the site data, and related information by which the cost for each site is associated with the plurality of data models; a processor; and an input/output unit,
the information processing method comprising:
a cost calculation processing step, which is executed by the processor, of receiving site identifying information for identifying a site from the input/output unit and calculating a first cost which is a cost of the site identified by the site identifying information based on site information of the site identified by the site identifying information; and
a data model selection step, which is executed by the processor, of selecting, based on the first cost and the related information, a specific data model corresponding to a site having a second cost similar to the first cost from among the plurality of data models and outputting the selected specific data model to the input/output unit.
